(19) United States
(12) Patent Application Publication
(10) Pub. No.: US 2002/0087526 A1
(43) Pub. Date: Jul. 4, 2002

(54) Information search and retrieval system

(76) Inventor: Dileep R. Rao, Golden Valley, MN (US)

Correspondence Address: MERCHANT & GOULD PC, P.O. BOX 2903, MINNEAPOLIS, MN, 55402-0903, US

(21) Appl. No.: 09/839,877

(22) Filed: Apr. 20, 2001

Related U.S. Application Data
(60) Provisional application No. 60/242,285, filed on Oct. 20, 2000.
(60) Provisional application No. 60/199,028, filed on Apr. 21, 2000.

(51) Int. Cl. G06F 7/00

(52) U.S. Cl. 707/3

(57) ABSTRACT

Improved systems and methods are described for accessing information over a distributed network, including the World Wide Web of the Internet and local area networks. The system and methods provide users a quick, efficient, and effective way to gather information of interest to them. Notably, the invention permits the gathering of information using not just entered queries, but also the characteristics of the user and the user's real-time opinion of the search results as they are displayed. In doing so, the user is given information that is tailored to that individual, and which reflects the individual's specific opinion of the relevancy of the search results.

### TECHNICAL FIELD

The present invention relates to systems and methods for the search and retrieval of information, including the search and retrieval of information accessible on computer networks. More particularly, an aspect of the invention relates to a dynamic information search and retrieval system utilizing an improved user interface and user profiles to selectively identify relevant networked information.

### BACKGROUND

In recent years, networked information systems have become widely available to individuals and organizations. These systems include local area networks (LANs) and wide area networks (WANs). Perhaps the most widely available of these networks is the World Wide Web of the Internet, which connects millions of users to home pages using a system of universal remote locators (URLs) to send and receive information from locations around the world.

As networked information systems have expanded, so too has the amount of data available on these systems, particularly the amount of information available on the Internet. Today, millions of home pages accessible by the Internet contain a seemingly endless array of information. Although an explosion of available information has occurred, the ability to locate useful information has become particularly challenging because of the shear volume and variety of information. This volume can make it exceedingly difficult to find specific information that an individual user desires.

One of the first efforts to address the problem of locating useful information has been to create computerized search engines that sort through the millions of web pages on the basis of user-entered queries. Depending upon the entered query, the search engines produce a list of potentially relevant web sites, which can be accessed through the search results. Unfortunately, existing search engines often fail to find the most relevant information. This problem is partially due to the fact that most search engines fail to consider the unique characteristics of each user, and fail to find information of interest to that user. Some search engines attempt to consider these characteristics, but fail to do so in an effective way because they are difficult and time consuming to use, or because they fail to properly consider the user's individual characteristics.

A further significant problem with many search engines, and computer interfaces in general, is that they are often inefficient at utilizing user actions. For example, users of the Internet and other networked databases typically wish to find relevant information as quickly and easily as possible. These users want to be able to locate the right information with as few keystrokes or mouse movements as necessary, and want to locate that information quickly. Unfortunately, many search engines require excessive wasted keystrokes from users as they sort through retrieved data, and are therefore relatively inefficient.

Yet another significant problem with many search engines is that they lack the ability to collect and process information about the user's satisfaction with the search. These search engines simply accept a query from a user, and then display page after page of listed web sites based upon this initial query without revising the search as the user reviews the pages. Thus, the complete search results are displayed for a user even if they are not all relevant, and the search results do not improve as they are reviewed by the user.

In view of this discussion, a need exists for improved systems and methods for searching the Internet and other networked databases.

### SUMMARY OF THE INVENTION

The present invention is directed to improved systems and methods for accessing information over a distributed network, including the World Wide Web of the Internet and local area networks. The invention provides users a quick, efficient, and effective way to gather information of interest. Notably, in certain implementations the invention permits the gathering of information using the characteristics of the user and the user's real-time opinion of the search results as they are displayed. In doing so, the user is given information that is tailored to that individual, and which reflects the individual's specific opinion of the relevancy of the search results.

In specific implementations the invention allows a user to quickly move between search results with a minimum of effort and with improved speed. The invention allows a search result (such as an Internet page) and a list of search results to be simultaneously displayed. A user can access a specific search result, and investigate links associated from the search result, yet quickly move to other search results by selecting another search result from the list. In this regard, the invention allows a user to move directly from one search result to another without returning to a previously displayed list or to previously displayed results. A user is able to conserve a significant amount of time because he or she does not have to page back through a series of viewed screens in order to get back to the original search results. This ability to examine a search result, including links to other pages within the search result, without having to back up to earlier results is a significant time and effort saver.

Another aspect of the invention is directed to an improved user interface permitting advantageous searching and review of search results. The interface is part of a computer system, and permits a user to conduct a search of multiple records within a database, and to then review these records in a manner such that the user provides immediate feedback on each reviewed record. In response to this feedback, the system evaluates the search and provides an updated list of search results. Thus, the system provides a first set of search results to a user, and then as the user sequentially reviews the results the system modifies the search in order to reflect the user's opinions of the results. In this manner, the quality of the search results actually improves while it is being reviewed, because the search results change to reflect the user's satisfaction.

In specific implementations the user interface is configured such that a rating box travels with a user from web page to web page. The traveling ratings box can be configured such that it is continuously displayed on the user's screen, or can be configured such that it appears in response to a user's actions, such as by passing the cursor over the back button of the web browser. In the latter implementation, when the cursor is passed over the back button a small window appears and gives users the option of rating the site. Upon selecting a rating, the small window automatically vanishes, and an additional search result appears or the user automatically goes to the previously displayed site. This additional search result is typically a modified search result based upon the rating of the previous site. Alternatively, if the user chooses not to provide a rating, the small window can provide additional functions, such as a back button or a jump button. The back button returns the user to the previously viewed web page, while the jump button returns the user to the search result list. Note, if the user inadvertently passes the cursor over the back button but does not wish to use the small window that appears, this small window will automatically be closed after a delay period.

In addition to providing an immediately improved search result, the interface allows for the collection of ratings about specific search results, such as web pages. Thus, the user is able to rate every web page they view, which is useful for subsequent searches by that same user or other users with similar characteristics. In certain implementations the rating data from the users is also made available to web page providers and allows those providers to improve upon their service by responding to these ratings.

In another aspect of the invention, a profile identifying characteristics of the user is provided, and the database is searched on the basis of the search terms and the user profile. The user profile may include user data such as the user's profession, education, age, gender, residence, preferred recreational activities, preferred entertainment activities, etc. The user data may be given equal weights, or may be assigned relative weights for importance.

The user profile typically changes over time in order to reflect changes in the user or in the user's preferences. Thus, if a user acquires a new job or becomes active in a new recreational activity, then the user can modify their user profile in order to reflect these changes. Similarly, if a user discontinues an activity, or loses interest in an activity, then the user profile may be adjusted for this change. For example, a user who is a student at a specific university may choose to modify their profile to reflect that they have graduated from the university and moved to another town. In this manner, the user may receive less information from searches geared toward students (such as local entertainment activities) and more information geared toward graduates (such as reunion activities).

In addition to making additions and deletions to a user profile, a user is able to prepare more than one profile, with each profile tailored to a specific need. Users can, for example, have a work profile and a private profile. The work profile may also include limitations that are not present in the private profile.

In use, the user profile may be compared to ratings from an aggregate of users. Alternatively, the user profile may be compared to some of an aggregate of other users who are similar to the user. Typically, the aggregate profile changes over time. When no user profile has been entered, the aggregate user profile can be used.

The invention is also directed to an improved rating method for evaluating networked information sources, the rating method suitable for use in dynamically searching the information sources. The method includes providing individual ratings of a plurality of information sources, each individual rating providing an evaluation of the information source by a single individual reviewing the source; and aggregate ratings of a plurality of information sources, each aggregate rating providing an evaluation of the information source by multiple individuals reviewing the source.

In addition to providing search results for users, the present invention is useful because it provides data that can be used to analyze public opinion and consumer interests. By combining the user profile with the user ratings, it is possible to provide real-time feedback about how various users view specific information, including their opinions on specific Internet pages. Thus, a web host is able to determine the general opinion of viewers of their site, but is also able to get information about the opinion of individual demographic groups. Specific uses for the information include mailing lists and marketing profiles. This information can include static information indicating recent opinions, but can also include a dynamic indication of how a site's ratings have changed over time, either in aggregate or on an individual basis. Thus, if a web site has become outdated or ineffective at meeting its purpose, the shifts in user evaluations will indicate this change at a very early time to provide an opportunity to improve the site.

Yet another aspect of the invention is its use in creating specialized search results based upon a specific search criteria. The specialized search results provide for compiled results of specific information gathered from within web sites. In certain implementations the invention provides for assembly of a set of search results that link beyond a home page and into the specific content of a site. In doing so, the invention provides for creation of results that allow a user access to the most desired information easily and efficiently. These specialized search results may be used to create shopping catalogs, specialized information collections, on-line magazines with content from numerous Internet sites, and other specialized results.

### DESCRIPTION OF THE DRAWINGS

FIG. 1 illustrates a system diagram constructed and arranged in accordance with the present invention.

FIG. 2 illustrates a logical block diagram of a system according to an example embodiment of the present invention.

FIG. 3 illustrates a first user interface constructed and arranged in accordance with an implementation of the present invention.

FIG. 4 illustrates a second user interface constructed and arranged in accordance with an implementation of the present invention.

FIG. 5 illustrates comparative flow charts showing the steps necessary to search a database using an implementation of the present invention and using a prior art method.

### DETAILED DESCRIPTION OF THE INVENTION

Environment and System

The present invention is directed to improved systems and methods for accessing information over a distributed network, including the World Wide Web of the Internet, local area networks, and other networks. The invention provides users a quick, efficient, and effective way to gather information of interest to them. The invention also optionally permits the gathering of information using not just entered queries, but also the characteristics of the user and the user's real-time opinion of the search results. In doing so, the user is given information that is tailored to that individual user, and which reflects the individual's real-time opinion of the results as they are reviewed.

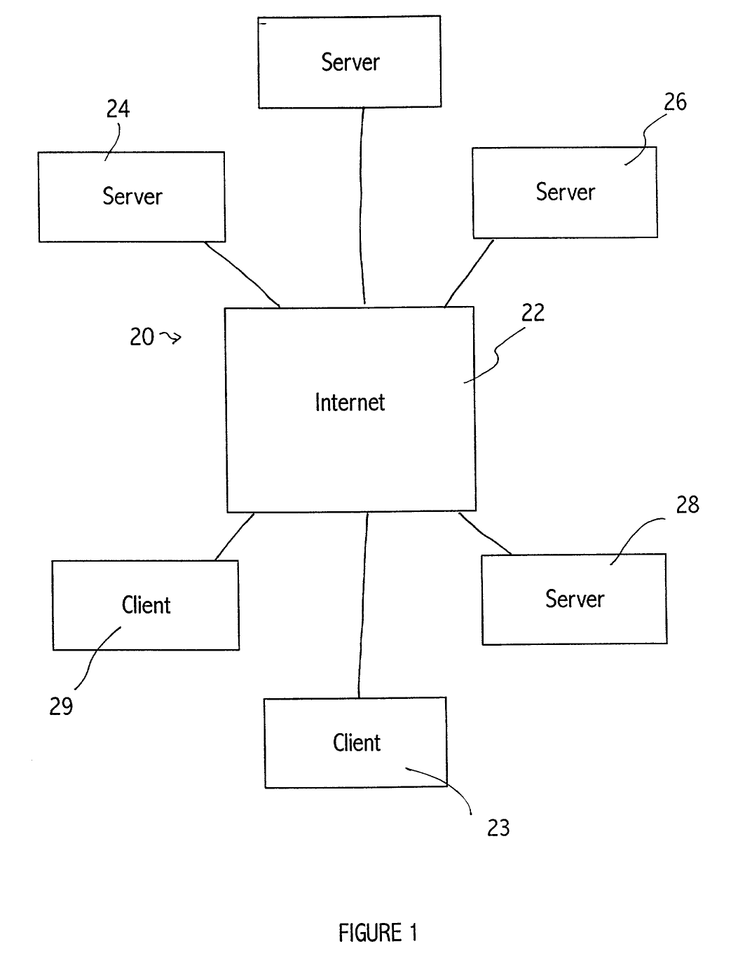

A typical environment in which the system and method operate is depicted in FIG. 1, which shows environment 20 and includes the Internet 22 as an example of a network comprising a database from which information may be obtained. The network includes a client computer 23 from which a user conducts a search. A first server 24 provides the search functionality, and searches web sites or other databases on a plurality of other servers 26, 28 etc. In use, the number of client and server computers is likely to be in the hundreds, thousands, or millions. Thus, the present invention is suitable for use over networked systems of greatly varying sizes. Other clients may also be present, such as client computer 29.

As used herein, the term database is used to identify a collection of information, such as web pages, computer files, etc. A database can exist on one computer or a plurality of computers. Thus, when searching web pages, those paces can all be located on one computer or multiple computers. For the sake of the present patent, the Internet is considered to be a database, as are local area networks.

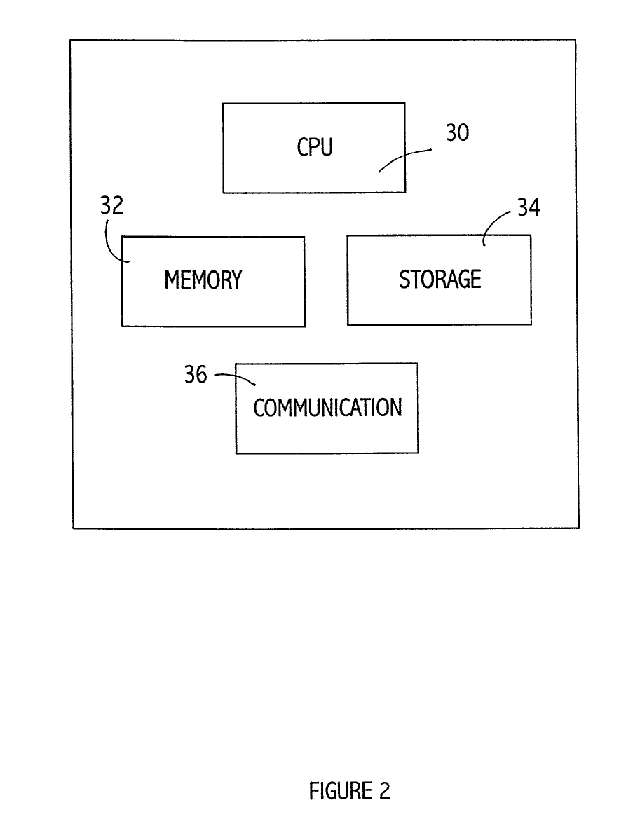

A system suitable for performing aspects of the present invention is shown in FIG. 2, and includes a central processor unit (CPU) 30, a memory location 32, a data storage location 34, and a communication location 36.

User Interface and Method

One aspect of the present invention is directed to an improved user interface for searching of networked information, as well as review of search results. The interface is part of a computer system, and permits a user to conduct a search of multiple records within a database, and to then review these records in a manner in which the user provides immediate feedback on each reviewed record. In response to this feedback, the system evaluates the search and provides an updated list of search results. Thus, the system provides a first set of search results to a user, and then as the user sequentially reviews the results, the system modifies the results in order to reflect the user's opinions of the results. In this manner, the quality of the displayed search results improves while the search is being reviewed, in contrast to existing search engines which typically show consecutively less relevant results.

The user interface of the present invention typically changes as search queries are entered and search results are provided. In one implementation of the invention the user interface includes a first screen containing fields for entering a query as well as for selecting a database or search engines to use. In other implementations, the search engines are automatically selected by the system of the invention. After the query and database or search engine have been selected, the search is conducted and a second screen appears containing the results of the search. This second screen displays one of the results of the search and also includes a list of the other results. By navigating through this second screen, as described below, a user selects and rates the search results. In response to this selection and review, the system of the invention modifies and enhances subsequently displayed results.

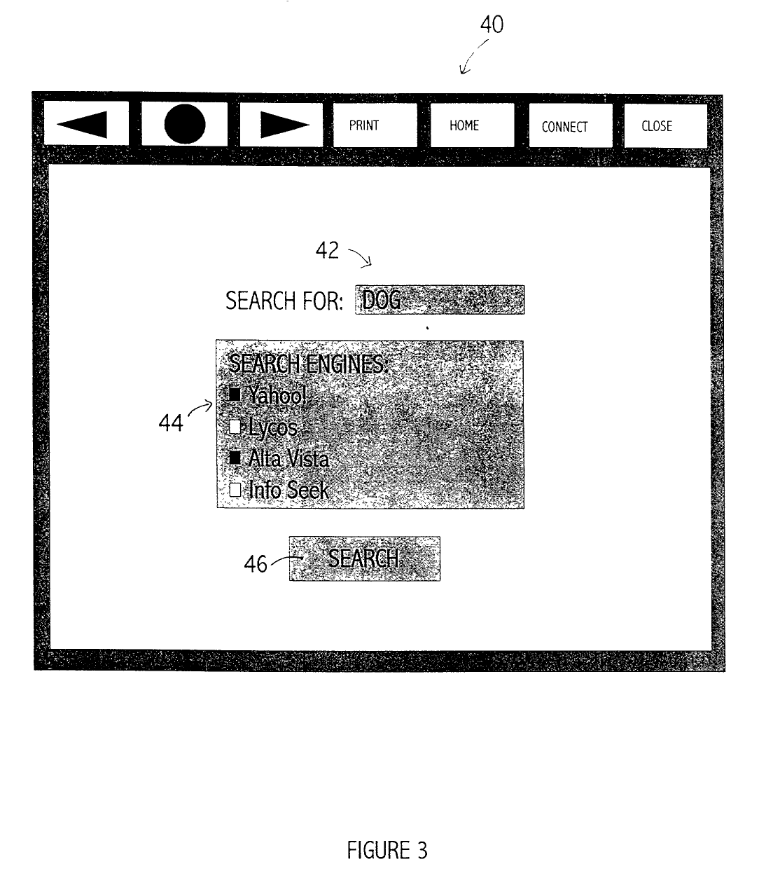

An exemplary first screen 40 of a typical user interface is shown in FIG. 3. First screen 40 includes a field 42 suitable for entry of an initial query by the user. In the embodiment depicted, a user is also able to select from a list of search engines 44 that the user wishes to use in the search. For illustrative purposes, first screen 40 in FIG. 3 shows a query for the word “dog” by a user who is interested in purchasing a pet dog. In addition, the user has selected Yahoo! and Lycos, two publicly available search engines, to conduct the search. After entering this query, or other query information, the user selects a search button 46, which sends the query to a processor, which conducts the search itself or assigns the search task to other computers.

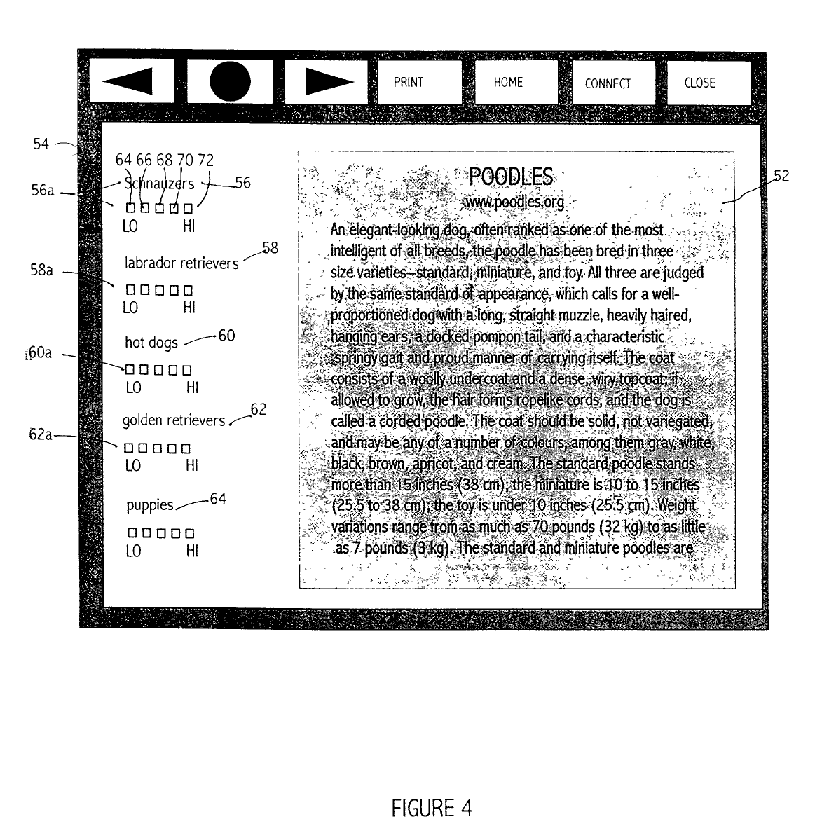

After the search has been conducted, the search results are returned to the user in the form of a second screen of the user interface, an implementation of which is shown in FIG. 4. Second screen 50 includes a first displayed search result 52 and a list 54 of additional summary search results 56-62. When searching the Internet, the first displayed search result 52 is typically a web page, and the list 54 of additional search results 56-62 typically includes a short title and descriptive summary of each web page.

Each of the additional summary search result 56-62 includes a corresponding series of rating fields for evaluating the currently displayed search result. These rating fields 56a-62a are normally provided in close proximity to a corresponding entry on the search results list 54. Thus, rating field 56a is in close proximity to search result 56, rating field 58a is in close proximity to search result 58, rating field 60a is in close proximity to search result 60, and rating field 62a is in close proximity to search result 62. More or fewer search results and rating fields may be displayed. Each rating field is used to rate or evaluate the currently displayed search result while simultaneously selecting the next search result. Thus, the currently displayed search result is rated by selecting a rating in one of the rating fields 56a-62a. Each rating field typically has a plurality of choices about how highly the currently displayed search result is valued. In the embodiment depicted, the ratings range from high 64 to low 72, with intermediate ratings 66, 68, and 70.

When a user is viewing a specific web page and wants to select an additional page, the user selects the rating field proximate the next search result they want to view. In the process of selecting the rating field for the additional page, the user provides a rating for the current field. Thus, the user selects a new result while rating the presently viewed result. In the view shown in FIG. 4, the currently displayed search result is the first displayed search result 52.

Use of this user interface is further explained by reference to the specific hypothetical example displayed in the figures. As indicated in FIG. 3, the user has entered the query “dog” with the intent to identify a breed of dog to purchase. The search results in FIG. 4 show that a first displayed result describing poodles. In addition, the list of search results contains, in order, results on such dog-related topics as schnauzers, Labrador retrievers, hot dogs (the food item), and golden retrievers. Upon review of the first displayed screen, the user is able to select from the list of other entries. Assuming the user is not interested in poodles, but is interested in a retriever, the user can select the rating field associated with the second item on the list, the Labrador retriever. Because the user was not interested in the poodle, he or she would typically give the poodle site a low rating value. In this manner, the user rates the existing page while also selecting a new page to view.

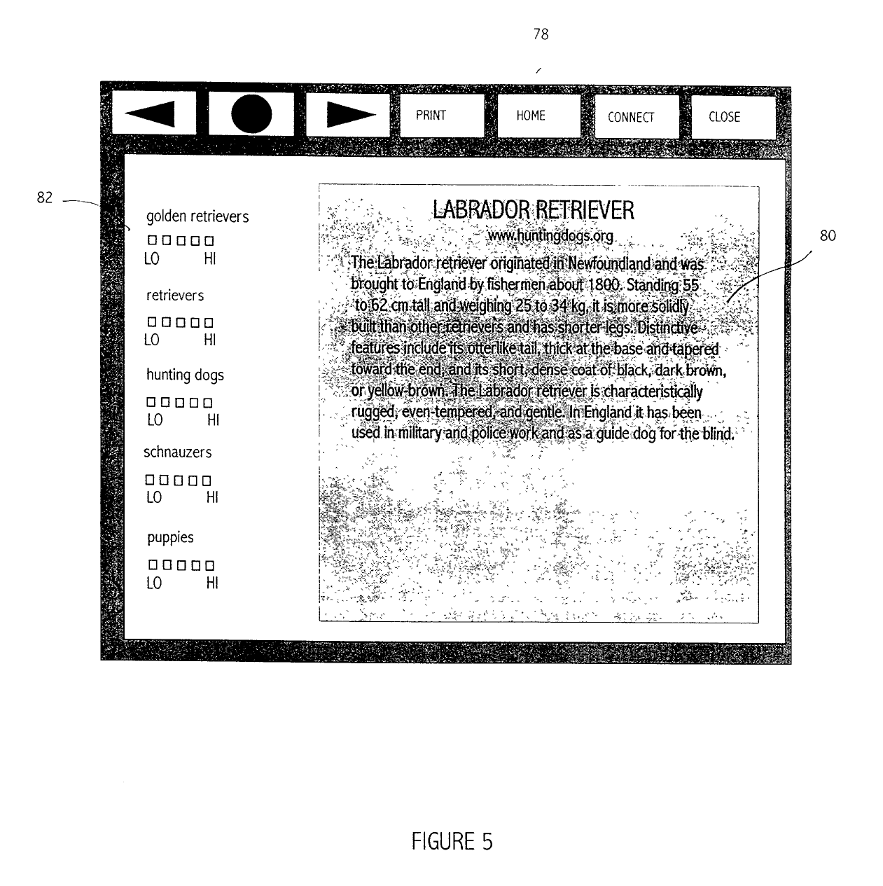

After making these selections, the new page 78 relating to the Labrador retriever is displayed as the new currently displayed result 80 as shown in FIG. 5, along with a revised list 82. The list is revised in order to reflect the rating that was received from the user in response to the page about poodles. In this example, the list has been reordered so that the result at the top of the search result list is also about retrievers. In addition, the site about hot dogs has been entirely removed from the list because it was evident that the user was more interested in canines than in food items.

As described more fully below, the ratings provided on each page may be used to reorder the search results, to modify the search, or to conduct a new search. In addition, the ratings are typically used in order to compare the user's preferences to those of other users with similar preferences. Thus, if a user indicates an interest in Labrador retrievers based upon their ratings of sites, then the search results can be reordered or reformatted to highlight other pages that received high ratings by users with an interest in Labrador retrievers.

The present invention provides improved search results because it gives users relevant information quickly, and improves the search results as they are viewed. Thus, even if the initial search results contain a number of irrelevant entries, these entries can be quickly eliminated using the rating system. Also, a entire class of irrelevant results can be quickly eliminated by giving a low rating to one of the results. Thus, following the example above of a user considering the purchase of a dog, if a number of sites relating to hot dogs is returned, the user must merely view one of these pages and give it a low rating to remove the other hot dog sites from the list.

Not only is the current user interface well suited to providing quality results, it is welling these results in a very efficient manner. A user must review far fewer screens using the improved interface than when using traditional interfaces that require the user to toggle between page views and the results list. For example, in order to view 10 sites using a traditional method, a user will view 23 web pages, while the improved user interface requires only 13 views, a net efficiency improvement of 43 percent. Similar efficiency gains are obtained when viewing more or fewer screens, as Table 1:

TABLE 1

| | Present Page | Improved User | Efficiency |
|---|---|---|---|
| Sites Viewed | Views | Interface | Improvement |
| 5 | 11 | 8 | 38 |
| 10 | 23 | 13 | 43 |
| 15 | 33 | 18 | 45 |
| 20 | 43 | 23 | 47 |
| 40 | 83 | 43 | 48 |

Notably, efficiency can be even higher when the user searches deep into a site because it is not necessary to backtrack through previously viewed pages in order to get back to the search results.

In the embodiment described above, the user interface includes separate screens for entry of the query, for viewing the first search results, and for viewing subsequent search results. In other implementations, these functions may be combined into fewer screens for the user interface. For example, the query entry fields, database selection fields, and the search engine entry fields may be displayed on the same page as the search results. This simultaneous display allows the user to more easily change the query to start a new search, or to alter the search engine or database, as desired.

Although most implementations of the invention utilize rating systems, it is also possible to use implementations of the present invention without a rating system. Thus, in specific implementations the user is able to directly select the next site that they wish to visit by selecting an entry from the list, without needing to backtrack through other pages. In such implementations, a user does not rate the sites, but still gains the benefit of having to make fewer selections with their pointing device, and thus is able to move more rapidly and efficiently through the search results.

It is desirable to use the improved system even when ratings are not provided. By displaying the list of search results simultaneously with displayed results, a user is able to quickly move from the displayed results to the list, and back and forth. These improvements are particularly useful when a user follows links in a result deep within a web site, and then wishes to go back to other search results (or even the first page of the current results).

A further aspect of the invention that allows the user to move rapidly between search results is that (in certain embodiments) the user can select a rating and then be automatically sent back or forward with a single click (i.e. ratings and navigation can be accessed with one click of a mouse or other entry device). This type of single click selection reduces the amount of effort that is required by a user, particularly when compared to systems that require a user to first select a rating and then to click back or forward again. In this manner, the search effort can be reduced in half by requiring just the single selection (that both rates and navigates) rather than a double selection (one to rate and one to go backward or forward in navigation).

Yet another optional aspect of the invention provides users with a rating box when the user seeks to leave the web page they are currently viewing. For example, when a user selects the “forward” or “backward” button on their web browser, a rating box appears that asks them to rate the page they are currently viewing. Upon entry of their rating (usually by simply selecting a rating value with one click of a mouse), the user is immediately directed to the “forward” or “backward” page that they have requested. In this manner, the user provides meaningful feedback on the web sites they are viewing with a minimum of time and effort. Similarly, if the user seeks to leave a current web page by entering a new URL or by going to a linked page, the rating box appears and requests a rating for the currently viewed page. In such implementations, after providing the rating, the user is automatically sent to the newly entered URL or to the link that they have selected.

Other modifications to the user interface are also appropriate for specific implementations of the invention. One such modification is the inclusion of fields for selecting the rating period to be used when searching. Thus, a user is able to selectively search only very recently rated materials or materials rated over a longer period of time. In addition, the user may make specific selections of what weight is to be giving to the users own profile, such as economic, interests, personal, etc. Yet other modifications include selection of which user profile to use.

The user interface can also include various enhancements that improve upon a user's ability to navigate through search results while also improving upon those search results. In one implementation, a user viewing a web page is able to seamlessly open a rating window and to then rate the existing site with as little as one click of their mouse. In such implementations, the user interface is configured such that a rating box travels with a user from web page to web page. The traveling ratings box can be configured such that it is continuously displayed on the user's screen, or can be configured such that it appears in response to a user's actions, such as by passing the cursor over the back button of the web browser. This function may be incorporated into the interface, for example, by a Java™ Applet running in the browser.

In the latter implementation, when the cursor is passed over the back button a small window appears and gives users the option of rating the site. Upon selecting a rating, the small window automatically vanishes, and an additional search result appears (without addititional clicks of the mouse). This additional search result can be (but is not always) a modified search result based upon the rating of the previous site. In some implementations, the rating received on the specific displayed web site is combined with additional information to provide an improved search result and a optimized subsequent result. For example, the newly received rating information can be combined with other rating information that the user has provided in response to different pages of the same search result. Alternatively, the rating information can be combined with information provided by other users. Thus, for example, if other users have given a specific web page low ratings, but other pages high ratings, then if the existing user gives the same specific web page a low rating, then the search results can selectively provide the other pages that the other users gave high ratings.

Alternatively, if the user chooses not to provide a rating, the small window can provide additional functions, such as a back button or a jump button. The back button returns the user to the previously viewed web page, while the jump button returns the user to the search result list. Note, if the user inadvertently passes the cursor over the back button but does not wish to use the small window that appears, this small window will automatically be closed after a delay period.

As described above, the new window opens up in a user's browser in response to an action, such as moving the cursor over a field in the interface. However, in other implementations, the new window remains open as the user moves among the search results. In such implementations, the new window remains on top, and can be dragged and dropped so that it is in a specific portion of screen based upon the user's preference (such as in the bottom, top, or along one of the sides). This window can remain open even when the user moves from screen to screen and from search result to search result. Optionally, the window can remain open and visible even when other applications, such as word processing applications, are open. By selecting the window, the user returns to the search results or to the most recently opened search results. In this manner the system stores a user's search results, and allows a user to seamlessly move between applications. Such implementations are particularly useful when a user is multitasking between various programs or when the user is reviewing the same search results over an extended period of time, including multiple sessions.

Display of Search Results

The present invention may be used to create specialized search results. The specialized search results allow linking past a home page and into the specific content of a site in order to create focused results that provide an organized user-friendly assembly of relevant information.

In certain implementations the invention provides for assembly of a set of search results that link beyond a home page and into the specific content of a site. In doing so, the invention provides for creation of results that allow a user access to the most desired information easily and efficiently. These specialized search results may be used to create shopping catalogs, specialized information collections, on-line magazines with content from numerous Internet sites, and other specialized results.

For example, if a user wishes to purchase a computer, he or she can search for computer characteristics, and the system provides search results from specific pages on the Internet that contain available products from various web sites. In this regard, the invention is advantageous because it provides a user with the specific Internet page on which the computers are displayed, not the general home page for the manufacturer or retailer. In this example, if a user is looking for a computer with a specific processor speed and specific amount of memory, the system will search Internet sites for advertised computers, and in particular will search for computers satisfying these speed and memory requirements. After the search is complete, the specific Internet pages that pertain to these computers are displayed. For example, if Dell, Compaq, and Toshiba all offer computers meeting these requirements, then the system displays the page related to each relevant computer, rather than simply directing users to the front page of the retailer. In this manner the system provides the specific information about each retailer's computers, not just the general information about the retailer.

An additional example is one in which the user is seeking to purchase a specific make and model of car. A search using the present system searches for dealers who carry cars satisfying the users needs, and then further searches on each dealer's site for the specific car. When displaying the search results, a user is provided with a display of the specific page or pages that satisfy the search criteria. Thus, rather than being provided with the home page for various dealers, the user receives the specific pages displaying the actual cars that satisfy the search query. This display of the specific search results rather than the general home pages saves time and effort by avoiding having to enter each dealer's home page and then subsequently searching through their various pages to find the actual automobile that is desired.

A further example of the invention is use to gather highly relevant information for users and then displaying the most relevant information for each user in a readily accessible manner. In one implementation a selection of information sources is searched, and then when relevant information is identified on a site the most specifically relevant pages are displayed. For example, a user who wishes to get articles about investing in international mutual funds can conduct a general search of various on-line publications. Rather than display the home page of each information source, the system of the invention provides the specific page containing the desired information. In addition, the system displays a list or table of contents that shows the other pages from other information sources. In this manner, the system and method of the invention provide an essentially tailored web site or “magazine” that contains numerous articles related to the issue of interest.

In one implementation the present system and method are performed by first searching for relevant web sites, and then subsequently searching deeper within each site to find the most relevant information. The search is first undertaken by searching for and identifying relevant home pages. After these home pages are identified, the search engine can follow links on each home page and search the linked pages for information that is relevant. These linked pages can subsequently be displayed. Alternatively, when the deeper sites are already available to be searched, then they may be immediately searched and relevant pages identified.

User Profiles

In another aspect of the invention, a profile identifying characteristics of the user is provided, and the database is searched on the basis of the search terms and the user profile. The user profile provides an opportunity for a user to personalize the search of the Internet or other networked databases for their own interests, experiences, etc. In this manner, a search can be improved because not only does it consider a specific query entered by a user, but it also considers other aspects about the user.

The user profile may include user data such as the user's profession, education, age, gender, residence; preferred recreational activities, preferred entertainment activities, etc., and is used to provide data that is most relevant to the user. The user profile interface may include entry fields for providing information about whether the user has previously created a user profile, as well as information for entering the users demographics, interests, attitudes, etc. The user may enter a member name as well as a password in the interface. The member name and password provide a secure means of accessing a user's profile, which is typically preserved on the server computer. Alternatively, the user's profile may be maintained on the client computer, in which case the information is sent to the server prior to each test. This later method can be desirable, for example, when the user desires to maintain confidentiality or when the user is accessing numerous servers using the method of the present invention. Thus, a user may create a profile and then use it to access a variety of different servers associated with different businesses or information providers. For example, the user may access an on-line book store, and use their user profile to select books, and then subsequently access a sports information service and use their user profile to access sports information. In the first instance, the profile could be used to get books most relevant to the users interests and hobbies, while in the second instance the user profile can be used to get information about the user's favorite sports teams or local sports teams.

The user data may be given equal weights when considered by the user, or may be assigned relative weights for importance. For example, a user who strongly identifies themselves as a resident of a specific state may choose to give particularly high weight to that aspect of their user profile. In such instances, the user will be more likely to receive information that other users from that state have also ranked highly. Examples of where such ratings can be important include selection of restaurants and for shopping. If a user from Virginia includes in their user profile that they have a strong preference for Virginia searches with the query “sea food”, the present system of the invention will find sea food sites that were ranked highly by other users who also include Virginia in their user profiles. In this implementation, the search is likely to find sea food restaurants in Virginia, which would be particularly useful for a Virginia user looking for a restaurant. Naturally, for such users a restaurant in any other geographic area would be of limited use, and therefore should be given much less weight during the search.

Although it would be possible to conduct a similar search by looking for both “Virginia” and “sea food” in the original search query, the present invention is advantageous because it looks not just for web sites that contain the word “Virginia”, but also for web sites that have been ranked highly by other users from Virginia (or with a high Virginia weight in their profile). In this manner the search takes on the understanding and opinions of many users (potentially thousands or millions) in order to provide a search result.

The use of the user profiles is particularly advantageous because it provides a continuously updating database that counters efforts of specific web pages to get themselves noticed, even though they may not be a particularly useful site. For example, in recent years many web pages have included meta-tags with repetitive terms in order to get as many search engines to spot them as possible. These pages often appear in search results, even though they are not particularly useful or well prepared. However, the present invention, using user profiles and user ratings, allows a user to avoid these sites by relying on the collective opinion of numerous users, as evidenced by their user profiles and site ratings.

In certain embodiments, the relative weights of a user's profile are adjustable by the user. Also, the user profile typically changes over time in order to reflect changes in the user or in the user's preference. Thus, if a user acquires a new job or becomes active in a new recreational activity, then the user can modify their user profile in order to reflect these changes. Similarly, if a user discontinues an activity, or loses interest in an activity, then the user profile may be adjusted for this change. For example, a user who is a student at a specific university may choose to modify their profile to reflect that they have graduated from the university and moved to another town. In this manner, the user may receive less information from searches geared toward students (such as local entertainment activities) and more information geared toward graduates (such as reunion activities).

In addition to making additions and deletions to a user profile, a user is able to prepare more than one profile, with each profile tailored to a specific need. Users can, for example, have a work profile and a private profile. The work profile may also include limitations that are not present in the private profile. For example, a work profile may indicate that the user does not wish to receive any sites that are not work related. For example, if a workplace does not allow individuals to search for non-work related information, then the user may want to exclude all sports sites, investment sites, etc.

Although the use of a user profile as described above has significant advantages for individuals searching a database, the use of it is optional in specific implementations of the invention, and is not included in other implementations. Therefore, users of the improved user interface and other aspects of the system and method of the invention can still benefit from its use even if they do not enter a user interface.

User Ratings

As discussed above, in addition to providing an immediately improved search result, the interface allows collection of ratings about specific search results, such as web pages. Thus, the user is able to rate every web page they view, which is useful for subsequent searches by that same user or other users. In certain implementations the rating data from the users is also made available to web page providers and allows those providers to improve upon their service by responding to these ratings.

The invention is also directed to an improved rating method for evaluating networked information sources, the rating suitable for use in dynamically searching the information sources. The method includes providing individual ratings of a plurality of information sources, each individual rating providing an evaluation of the information source by a single individual reviewing the source; and aggregate ratings of a plurality of information sources, each aggregate rating providing an evaluation of the information source by multiple individuals reviewing the source. In one implementation, the rankings change dynamically between page views.

In addition to providing ratings of specific web pages or web sites, the present invention can allow for entry of user ratings on specific products or services offered at a site. Thus, not only can the search results be evaluated for relevancy and quality of the site, but the quality of the products on a specific site can be rated. For example, ratings of automobiles, electronics, software, etc. can all be made using the system and method of the invention.

Although the ratings of the present invention are typically provided in a scaled form that can be quantified for comparative purposes, the present invention also includes providing opinions of sites and/or search results. For example, the user interface of the invention can include an area for entering comments about a web page. When the search results are returned to future users, these comments can be provided to those users so as to inform them how other individuals evaluated the site. In specific implementations, these comments can be filtered so that the comments provided to other users are provided from individuals who have the most common rating of a site. For example, if most users of a site rate it a 5 out of 10, then the comments of users who gave it a 5 (or a 4 or a 6, for example) can be provided to other users. Similarly, if most users of a site rate it as a 9 out of 10, then the comments of users who gave it a high score (such as an 8, 9, or 10), can be provided to other users. In this manner, outlying information can be removed in order to prevent skewing of the impressions of infrequent users who don't have time to read all of the possible reviews. Alternatively, in specific implementations the users are given all of the reviews, or are given the option of receiving all of the reviews.

Search Protocol

A further implementation of the invention is directed to a method of searching a database, the method comprising providing an aggregate user profile, and selecting information from the database on the basis of the aggregate user profile. Individuals may have a plurality of user profiles depending upon where used.

This data is typically provided by users as they access the web pages. After records have been initially identified, the first record is displayed. This first record is typically the record considered by the search protocol to be the most relevant record. In addition to displaying the first record, a list of the search results is displayed. The list identifies selected records and including an evaluation button(s) associated with each of the records. In order to access additional records, the evaluation button(s) associated with the record is selected. By selecting the evaluation button the user evaluates or rates the existing record while also selecting a new record. In this manner, the user efficiently provides both a rating of a current web page while also selecting a new web page to view.

When performing searches in accordance with the invention, the searches may be made using one or more search engines. In specific implementation the user selects the search engine. In other implementations the search engines are automatically selected by the system of the invention. In such implementations, the search engines that are used to conduct the search can be selected based upon the success of prior searches for similar information. Thus, if one search engine typically is rated highest at locating sports information, then that search engine can be used first by the system when searching for information relating to sports (as identified, for example, by search containing keywords such as “football”, “game”, “team”, etc.. Similarly, if one search engine is typically rated highest when searching web sites of a specific country, then that search engine can be used first by the system when searching for information relating to that country (such as information containing that country's name).

Data Utilization

In addition to providing search results for users, the present invention is useful because it provides data that can be used to analyze public opinion and consumer interests. By combining the user profile with the user ratings, it is possible to provide real-time feedback about how various users view specific information, including their opinions on specific Internet pages. Thus, a web host is able to determine the general opinion of viewers of their site, but is also able to get information about the opinion of individual demographic groups. Specific uses for the information include mailing lists and marketing profiles.

This information can include static information indicating recent opinions, but can also include a dynamic indication of how a site's ratings have changed over time, either in aggregate or on an individual basis. Thus, if a web site has become outdated or ineffective at meeting its purpose, the changes in user evaluations will indicate this change at a very early time to provide an opportunity to change.

The data of the present invention can be used to evaluate competitor sites.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. A method of searching a database, the method comprising:
providing an individual user profile containing individual profile characteristics about an individual user;
providing an aggregate user profile of a plurality of users containing aggregate user profile characteristics;
providing at least one search term from the individual user; and
conducting a search of the database using search criteria, the search criteria including at least one common individual profile characteristic and aggregate profile characteristic.

2. The method according to claim 1, wherein the aggregate user profile is formed from a plurality of users having user profiles with at least one common profile characteristic.

3. The method according to claim 1, wherein the individual user has more than one user profile.

4. The method according to claim 1, wherein the individual user has a plurality of user profiles.

5. A data signal embodied in a transmission medium, the signal:
rating a record currently displayed; and
identifying a record to display.

6. The data signal according to claim 5, wherein the rating provides a scaled rating of the record currently displayed.

7. The data signal according to claim 5, wherein the record to display is selected from a list of search results.

8. A method in a computer system for displaying search and retrieval information, the method comprising:
conducting a search of records within at least one database;
simultaneously displaying a first record identified from the search and a list of records identified from the search; and
subsequently displaying a second record identified from the search by selecting the second record from the list of records.

9. The method according to claim 8, further comprising displaying a plurality of records linked to the first record prior to selecting the second record from the list of records.

10. The method according to claim 8, further comprising providing an evaluation input of each record.

11. The method according to claim 8, further comprising providing a user profile for a user performing the method.

12. A method in a computer system for displaying search and retrieval information, the method comprising:
conducting a search of records within at least one database;
displaying a first record identified from the search;
displaying a list of the search results, the list identifying selected records and an evaluation input associated with each of the records; and
selecting a second record identified from the search by selecting the evaluation input associated with the record; and
wherein the evaluation input provides a rating of the first record.

13. The method according to claim 12, wherein conducting a search of multiple records comprises:
receiving search terms from a user conducting the search;
providing a user profile identifying characteristics of the user; and
searching the database on the basis of the search terms and user profile.

14. The method according to claim 12, wherein the user profile includes user data selected from the group consisting of: profession, education, age, gender, residence, preferred recreational activities, preferred entertainment activities, and combinations thereof.

15. The method according to claim 14, wherein the user data is assigned relative weights of importance.

16. The method according to claim 14, wherein the relative weights are adjustable by a user.

17. The method according to claim 14, wherein the user profile changes over time.

18. The method according to claim 12, wherein conducting a search of multiple records further comprises:
providing an aggregate profile combining a plurality of user profiles; and
searching the database using search criteria including the search terms, the user profile, and the aggregate user profile.

19. The method according to claim 18, wherein the aggregate profile is formed from a plurality of user profiles having at least one common user characteristic.

20. The method according to claim 12, wherein the evaluation input comprises a rating system.

21. The method according to claim 20, wherein the rating system is a scaled rating system.

22. The method according to claim 12, wherein the database comprises a networked database.

23. The method according to claim 12, further comprising:
displaying a second list of search results based upon the rating of the first record.

24. The method according to claim 18, wherein the search includes searching using an aggregate profile.

25. A rating method for evaluating networked information sources, the rating system suitable for use in dynamically searching the information sources, the method comprising:
a) providing individual ratings of a plurality of information sources, each individual rating including an evaluation of the information source by a single individual reviewing the source; and
b) providing aggregate ratings of a plurality of information sources, each aggregate rating including an evaluation of the information source by multiple individuals reviewing the source;
wherein the aggregate ratings include identifying characteristics of each reviewer.

26. The rating method according to claim 25, wherein the individual ratings of the plurality of information sources are sequentially entered concurrent with the selection of information sources to review.

27. The rating method according to claim 25, further comprising:
selecting individual information sources from the plurality of information sources based upon the individual ratings.

28. The rating method according to claim 25, further comprising:
selecting individual information sources from the plurality of information sources based upon the individual ratings and the aggregate ratings.

29. The rating method according to claim 25, further comprising ranking the plurality of information sources based upon the individual ratings and aggregate ratings.

30. The rating method according to claim 25, further comprising repeatedly modifying the ranking of the plurality of information sources based upon additional individual ratings.

31. A computer data signal embodied in a transmission medium, the data signal comprising:
a first portion identifying the results of a search of multiple records within at least one database;
a second portion identifying a first record located by the search;
a third portion identifying a list of the search results, the list indicating selected records and an evaluation input associated with each of the records; and
wherein each evaluation input provides a rating of the first record.

32. A method of searching and displaying search results, the method comprising:
searching at least one networked database of information-containing records;
identifying a plurality of relevant information-containing records;
compiling a list of the information-containing records; and
displaying the list concurrently with displaying at least one of the information-containing records;
wherein display of other information-containing records is initiated by selecting from the list of the information-containing records.

33. The method according to claim 32, wherein:
at least some of the plurality of relevant information-containing records include links to other information-containing records; and
searching these other information containing records.

34. The method according to claim 32, wherein the plurality of information-containing records comprises individual product records from multiple providers.

35. The method according to claim 32, wherein the plurality of information-containing records comprises individual news articles from a plurality of news sources.

36. A method in a computer system for evaluating search results, the method comprising:
searching at least one networked database of information-containing records;
displaying at least one search result in a first window;
displaying a second window containing rating requests; and
rating the search result in the first window by selecting a rating request in the second window.

37. The method according to claim 36, wherein the second window further contains one or more navigational buttons.

38. The method according to claim 37, wherein the navigation buttons include a back button to return to a previously displayed page.

39. The method according to claim 37, wherein the navigation buttons include a jump button to move to a list of the search results.

40. The method according to claim 36, wherein the second window is displayed upon movement of a cursor over a field of the first window.
